(19) United States
(12) Patent Application Publication
(10) Pub. No.: US 2015/0066979 A1
(43) Pub. Date: Mar. 5, 2015

(54) DEVICE ADDRESS MANAGEMENT IN AN AUTOMATION CONTROL SYSTEM

(71) Applicants: Qing Zhang, North Andover, MA (US); Ron Naismith, North Andover, MA (US); Merrill Harriman, Hudson, NH (US); Nicolas Riou, Meylan (FR)

(72) Inventors: Qing Zhang, North Andover, MA (US); Ron Naismith, North Andover, MA (US); Merrill Harriman, Hudson, NH (US); Nicolas Riou, Meylan (FR)

(73) Assignee: SCHNEIDER ELECTRIC INDUSTRIES SAS, Rueil Malmaison (FR)

(21) Appl. No.: 14/384,905

(22) PCT Filed: Mar. 15, 2012
(86) PCT No.: PCT/US12/29233

§ 371 Date: Sep. 12, 2014

(51) Int. Cl. G05B 19/05; G06F 17/30; H04L 12/24

(52) U.S. Cl. CPC G05B 19/054; H04L 41/50; G06F 17/30424
USPC 707/769; 709/223

(57) ABSTRACT

Systems, methods, and computer-readable media provide a mapping database for mapping device identifiers to network addresses and vice versa. Device identifiers and their corresponding network addresses may be stored in the mapping database. Data may be received from an input/output device and converted into a device identifier. Also, data may be received through a user device and converted into a network address. The mapping database may be populated using various protocols. Further, the mapping database may store various types of network addresses so that a controller may communicate with various types of input/output devices using various protocols.

### FIELD OF ART

Aspects of the disclosure generally relate to managing addresses of devices within an automation control system.

### BACKGROUND

Automation control systems are used to control processes in a variety of settings, including industrial environments where multiple input/output (I/O) devices (e.g., sensors, actuators, etc.) are simultaneously controlled. More and more goods are created using automation control systems to manage the manufacturing processes.

One component of an automation control system may be a programmable logic controller (PLC). PLCs are built to withstand harsh conditions, such as higher/lower temperatures, excessive vibrations, etc. Moreover, PLCs allow many different I/O devices to be controlled from a single interface.

In conventional control systems, PLCs communicate with I/O devices by referencing these devices via network addresses comprising complex strings of alphanumeric characters and other symbols. Therefore, end users often find it difficult to remember or associate these network addresses with the physical equipment that are referenced by these network addresses.

Accordingly, new systems and methodologies are required to allow for easier communication between network devices within a control system.

### BRIEF SUMMARY

In light of the foregoing background, the following presents a simplified summary of the present disclosure in order to provide a basic understanding of some aspects of the invention. This summary is not an extensive overview of the invention. It is not intended to identify key or critical elements of the invention or to delineate the scope of the invention. The following summary merely presents some concepts of the invention in a simplified form as a prelude to the more detailed description provided below.

Aspects of the disclosure address one or more of the issues mentioned above by disclosing methods, computer readable media, and apparatuses for providing device address mapping in an automation control system.

In some aspects of the disclosure, a PLC may include a mapping database, which may store device identifiers and their respective network addresses for one or more input/output (I/O) devices connected to the PLC. The mapping database may be populated using various methods and protocols so that each I/O device controlled by the PLC may have a unique network address. Further, the PLC may interpret computer-executable instructions that reference I/O devices using easily interpretable device identifiers (e.g., identifiers that are representative of the functionality of a given I/O device, etc.), identify network addresses corresponding to the device identifiers using the mapping database, and transfer data to the I/O devices using the identified network addresses.

In additional aspects of the disclosure, the PLC may receive data from an I/O device, identify a network address included within the received data, map the identified network address to a corresponding device identifier, and output a message including the mapped device identifier to a user. Because the outputted message references the I/O device using the easily interpretable device identifier, as opposed to a complex string of characters comprising the I/O device's network address, the user may easily understand details about the message, such as what information the I/O devices have detected, how certain I/O devices are performing, etc.

Of course, the methods and systems of the above-referenced embodiments may also include other additional elements, steps, computer-executable instructions or computer-readable data structures. In this regard, other embodiments are disclosed and claimed herein as well. The details of these and other embodiments of the present invention are set forth in the accompanying drawings and the description below. Other features and advantages of the invention will be apparent from the description and drawings and from the claims.

### BRIEF DESCRIPTION OF THE DRAWINGS

The present invention is illustrated by way of example and is not limited in the accompanying figures in which like reference numerals indicate similar elements and in which:

FIG. 1 is a block diagram of an example automation network that may be used according to an illustrative embodiment of the present disclosure.

FIG. 2 is a block diagram of an example computing device that may be used according to an illustrative embodiment of the present disclosure.

FIG. 3 illustrates a flow diagram for an example process in accordance with aspects of the present disclosure.

FIG. 4 illustrates a flow diagram for an example process in which device identifiers are mapped to network addresses in accordance with aspects of the present disclosure.

FIG. 5 illustrates a flow diagram for an example process in which network addresses are mapped to device identifiers in accordance with aspects of the present disclosure.

FIGS. 6-12 are example high level diagrams illustrating various aspects of the present disclosure.

### DETAILED DESCRIPTION

In accordance with various aspects of the disclosure, methods, computer-readable media, and apparatuses are disclosed that allow users to identify devices by meaningful device identifiers. The methods, computer-readable media, and apparatuses disclosed herein may be used for various automation control systems. Further, the methods, computer-readable media, and apparatuses may be implemented in various network configurations and with various network protocols.

In some aspects of the disclosure, computer-executable instructions are interpreted to determine a device identifier, the device identifier is translated into a network address using a mapping database, and data is transmitted to the device having the identified network address. The mapping database may be included within a controller, such as a PLC.

In the following description of the various embodiments of the disclosure, reference is made to the accompanying drawings, which form a part hereof, and which show, by way of illustration, various embodiments in which the disclosure may be practiced. It is to be understood that other embodiments may be utilized and structural and functional modifications may be made.

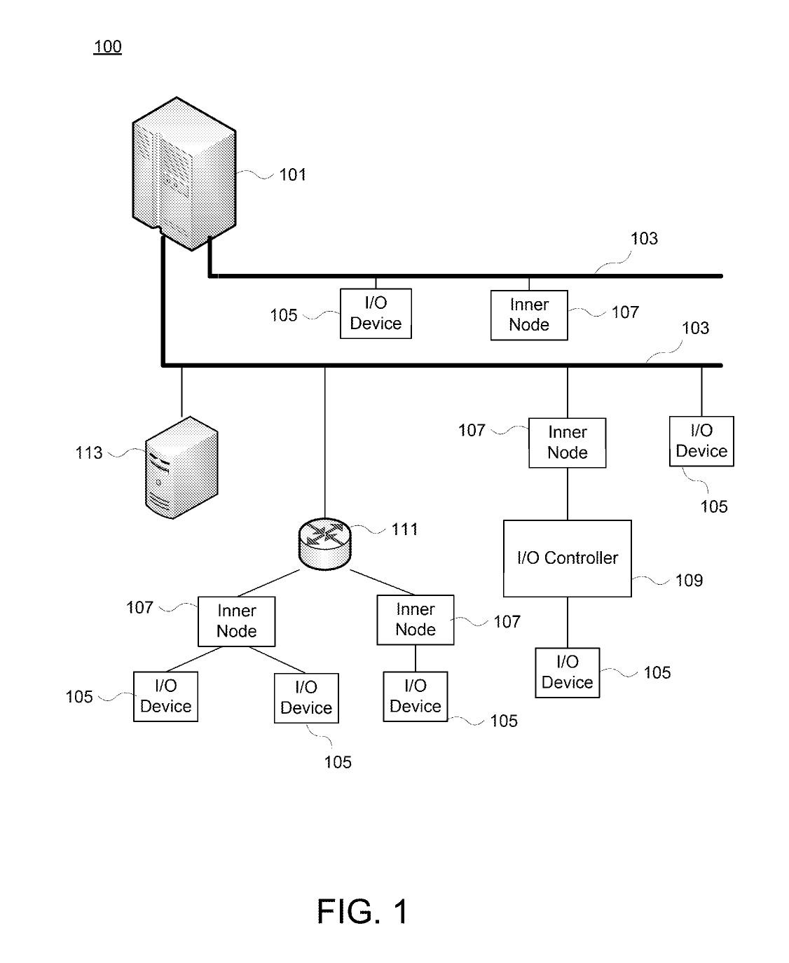

FIG. 1 illustrates a block diagram of an example automation network 100. The automation network 100 may be an industrial automation network for performing various control processes. The automation network 100 may include a PLC 101, a data bus 103, input/output (I/O) devices 105, inner nodes 107, an I/O controller 109, a switch or router 111, and a server 113.

In FIG. 1, the PLC 101 is shown as a single device; however, the PLC may include one or more devices that collectively form a PLC. That is, one or more devices may be in communication to control an automated process. In some embodiments, the devices constituting the PLC 101 may be arranged in different locations. Also, the PLC 101 may communicate with one or more additional PLCs that control other automated processes. The other automated processes may or may not be related to the automated process of the PLC 101. For example, the PLC 101 may control a first process and may be in communication with a second PLC that controls a second process that is part of the same control system.

As shown in FIG. 1, the PLC 101 may be connected to other devices via one or more data busses 103 (e.g., a backplane, etc.). The data busses 103 provide a physical layer for communications between the PLC 101 and the other devices. The communications may be transferred in accordance with any protocol, such as the Transfer Control Protocol/Internet Protocol (TCP/IP), User Datagram Protocol/Internet Protocol (UDP/IP), Ethernet Industrial Protocol (EtherNet/IP), PROFIBUS, Modbus TCP, DeviceNet, Common Industrial Protocol (CIP), etc. Also, the same PLC 101 may be connected to different types of data busses 103. The data busses 103 may be implemented with any type of wired connection, such as twisted pair wires, an optical fiber, a coaxial cable, a hybrid fiber-coaxial cable (HFC), an Ethernet cable, a universal serial bus (USB), FireWire, etc. Further, the same data bus 103 may include multiple types of connections joined together by adapters, switches, routers, etc.

FIG. 1 also illustrates that the PLC 101 may be connected to other devices via a wireless connection. In such embodiments, the PLC 101 may include wireless circuitry (e.g., an antenna). Alternatively, the PLC 101 may be connected to a wireless access point (e.g., a wireless router) to communicate wirelessly with other devices. The wireless connection may be any wireless connection, such as an IEEE 802.11 connection, an IEEE 802.15 connection, an IEEE 802.16 connection, a Bluetooth connection, a satellite connection, a cellular connection, etc.

Various types of devices may be connected to the PLC 101. As shown in FIG. 1, the PLC 101 may be directly connected to the I/O devices 105. That is, data transferred between the PLC 101 and the I/O devices 105 may only pass through the data bus 103.

However, in some cases, one or more inner nodes 107 may exist between the PLC 101 and the I/O devices 105. In some embodiments, the inner nodes 107 may be directly connected to the data bus 103. The inner nodes 107 represent any type of node within the automation network that is not an end node (e.g., not an I/O device 105). The inner nodes 107 may have their own Media Access Control (MAC) address, and may or may not have an IP address. The inner nodes 107 may improve the scalability of the automation network 100. That is, inner nodes 107 may allow the automation network 100 to be extended/expanded to include additional I/O devices 105. In other aspects, inner nodes 107 may serve as communication modules (COM modules) for assisting PLC 101 in communicating with various I/O devices 105. FIG. 1 shows that one inner node 107 may service more than one I/O device 105. In such cases, the inner node 107 may be configured to read data received from the PLC 101, determine the IP address of the I/O device to which the data should be transmitted, and route the data to the intended I/O device 105 that it services.

Further, I/O controllers 109 may be added to assist in interfacing a particular I/O device 105 with the data bus 103 or other devices within the automation network 100. I/O controllers 109 may be used where a particular I/O device 105 is not equipped with the proper interface to communicate with the PLC 101 or other devices on the network. Accordingly, I/O controllers 109 may also help in improving the scalability of the automation network 100 to include a wide range of I/O devices 105.

In some embodiments, a switch or router 111 may be incorporated into the automation network to direct communications to certain inner nodes 107, I/O devices 105, and/or other networks. Although only one switch 111 is shown in FIG. 1, a number of switches 111 may exist within the same embodiment.

Also, in some embodiments, the automation network 100 may include a server 113 connected to the PLC 101. The server 113 may allow for a cloud computing environment to be implemented. The server 113 may be placed in a location in the same proximity (e.g., same factory) as the PLC 101, and thus, may be directly connected to the data bus 103 as shown. Or, the server 113 may be placed in a remote location and separated from the PLC 101 by an external network, such as the Internet. Although only one server 113 is shown in FIG. 1, a number of servers 113 may exist within the same embodiment. In other embodiments, server 113 may represent a host computing device that provides the PLC 101 with data or programming that represents a desired operation or function to be performed by the PLC 101. In yet other embodiments, server 113 may represent a human-machine interface that may allow a user to program PLC 101 to perform an intended function. One of ordinary skill in the art would understand that one or more of these embodiments for server 113 may exist simultaneously as separate devices and/or may be combined into a single device within network 100.

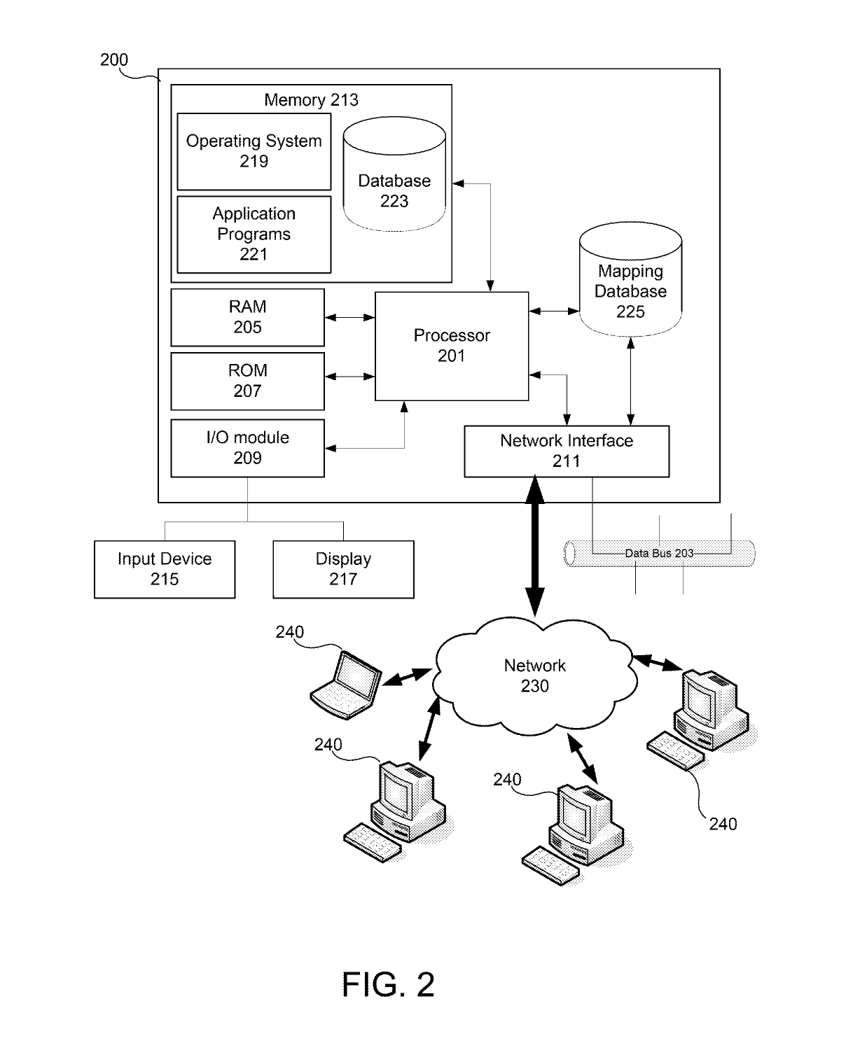

FIG. 2 illustrates a block diagram of an example computing device 200 that may be used according to an illustrative embodiment of the present disclosure. The computing device 200 may have a processor 201 that may be capable of controlling operations of the computing device 200 and its associated components, including RAM 205, ROM 207, an input/output (I/O) module 209, a network interface 211, memory 213, and a mapping database 225.

The I/O module 209 may be configured to be connected to an input device 215, such as a microphone, keypad, keyboard, touch screen, and/or stylus through which a user of the computing device 200 may provide input data. The I/O module 209 may also be configured to be connected to a display 217, such as a monitor, television, touchscreen, etc., and may include a graphics card. Thus, in some embodiments, the input device 215 and/or display 217 may provide a graphical user interface for the computing device 200. The display and input device are shown as separate elements from the computing device 200; however, they may be within the same structure in some embodiments.

The memory 213 may be any computer readable medium for storing computer-executable instructions (e.g., software). The instructions stored within memory 213 may enable the computing device 200 to perform various functions. For example, memory 213 may store software used by the computing device 200, such as an operating system 219 and/or application programs (e.g., a control application) 221, and may include an associated database 223.

The network interface 211 allows the computing device 200 to connect to and communicate with a data bus 203 and/or a network 230. The data bus 203 may be similar to the data bus 103 described above with regards to FIG. 1. Meanwhile, the network 230 may be any type of network, such as a wide area network (WAN) (e.g., the Internet) and a local area network (LAN). Through the network 230, the computing device 200 may communicate with one or more computing devices 240, such as laptops, notebooks, smartphones, personal computers, servers, etc. The computing devices 240 may also be configured in the same manner as computing device 200. In some embodiments the computing device 200 may be connected to the computing devices 240 to form a “cloud” computing environment.

The network interface 211 may connect to the network 230 via communication lines, such as coaxial cable, fiber optic cable, etc. or wirelessly using a cellular backhaul, wireless standard 802.11, etc. In some embodiments, the network interface 211 may include a modem. Further, the network interface 211 may use various protocols, including TCP/IP, Ethernet, File Transfer Protocol (FTP), Hypertext Transfer Protocol (HTTP), etc., to communicate with other computing devices 240.

The mapping database 225 may be a separate storage device or may comprise a block of memory within RAM 205, ROM 207, and/or database 223. The mapping database 225 may include one or more types of memory, including volatile and non-volatile memory. The mapping database 225 may store device identifiers for each device connected to the computing device 200 via the data bus 203. For example, where the computing device 200 is the PLC 101, device identifiers may be assigned for each device connected to the PLC 101, including the I/O devices 105, inner nodes 107, I/O controllers 109, etc. However, in some embodiments, the device identifiers may only be assigned for the I/O devices 105. Herein, device identifiers may be any string of alphanumeric characters and symbols that provides a meaningful representation (e.g., of functionality, etc.) of its corresponding I/O device 105. For example, a device identifier for a gate sensor may be “Gate Sensor 1,” while a device identifier for a motor's starter may be “Forward Motor Starter.” By assigning a device identifier to I/O devices 105, a user or operator of an automation control system may more efficiently interface with the PLC 101 to control the automation control system 100.

Further, the mapping database 225 may store a corresponding network address for each of the device identifiers. Network addresses may be any address used by any protocol to communicate with I/O devices 105. For example, a network address may include an IPv4 address of the Internet Protocol version 4 (IPv4) or an IPv6 address of the Internet Protocol version 6 (IPv6). Thus, the mapping database 225 may be configured so that it can store network addresses of different sizes.

Herein, the mapping database 225 may be configured so that the device identifiers are associated (or affiliated) to one or more corresponding network addresses. This may be accomplished by including a pointer to another memory address where the corresponding data is located. In other words, memory including a device identifier may also include a memory address to another portion of memory that includes the associated network address and vice versa. Alternatively, the mapping database 225 may be structured so that a first portion of data (e.g., a first group of bits) corresponds to one of the device identifier and network address, while a second portion of the same data (e.g., a second group of bits) corresponds to the other. In some embodiments, each device identifier is unique and affiliated with at least one unique network address. Another aspect of the mapping database 225 may be that it is organized in a particular manner that facilitates searching. For example, the mapping database 225 may be organized in alphabetic order based on the device identifiers. Moreover, the mapping database 225 may be configured so that its capacity can increase or decrease depending upon demand (e.g., depending on the number of I/O devices 105 connected to the data bus 203).

In some embodiments, the mapping database 225 may be secured so that only the processor 201 may access its contents. Also, although the mapping database 225 is shown in the same structure of the computing device 200, the mapping database 225 may be in a separate structure in other embodiments. For example, the mapping database 225 may be in another computing device 240 connected to the computing device 200 via the network 230.

In one or more embodiments of the present disclosure the PLC 101 may be configured in the same or in a similar manner as the computing device 200. The computing device 200 may also be a mobile device (e.g., a movable PLC, a laptop, a smartphone, etc.), and thus, may also include various other components, such as a battery, speaker, and antennas (not shown).

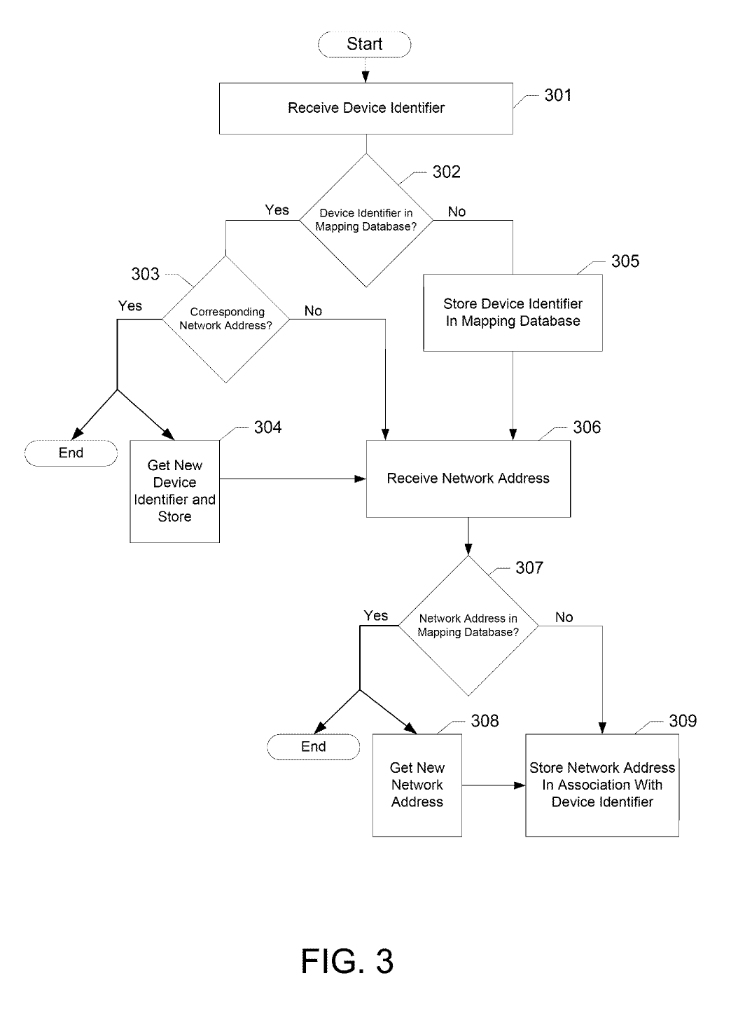

FIG. 3 illustrates a flow diagram of an example process in accordance with aspects of the present disclosure. The process of FIG. 3 may be performed by a processor 201 of the PLC 101 according to a control application. When the PLC 101 having the mapping database 225 is first installed in an automation network 100, the mapping database 225 might not have all of the desired data. That is, the mapping database 225 of the PLC 101 might not include a device identifier and a network address for each of the I/O devices 105 in the automation network 100. In some embodiments, the PLC 101 may be installed or manufactured with a mapping database 225 having all of the data already inserted; however, this might not always be the case. Thus, the process of FIG. 3 may be performed to populate the mapping database 225.

In some embodiments, the process of FIG. 3 may be performed only once at the time the PLC 101 is first installed in the automation network 100. In other embodiments, the process of FIG. 3 may be performed each time the automation network 100 and/or the PLC 101 is powered-up. For instance, where the mapping database 225 includes volatile memory, which cannot maintain stored data during an off state, the process of FIG. 3 may be performed every time the PLC is powered-up so that the mapping database 225 can be restored. Or, the PLC 101 may be designed to erase the mapping database 225 each time it is powered-up so that the process of FIG. 3 is performed to newly populate the mapping database 225. Still, in other embodiments, the process of FIG. 3 may be performed each time a new device (e.g., a new I/O device 105) is added to the automation network 100. Further, the process of FIG. 3 may be performed periodically or in response to a user input.

The process of FIG. 3 begins with step 301 in which a device identifier is received. The device identifier may be received at the PLC 101 via the data bus 103. The device identifier received in step 301 may be received in any manner. For example, the device identifier may be pushed from a device (e.g., an I/O device 105), entered manually, or received in response to a request sent by the PLC 101. At the physical layer, in step 301, the network interface 211 may transfer the device identifier to the processor 201 for further evaluation.

Next, in step 302, the device identifier may be analyzed to determine whether it exists in the mapping database 225. In some embodiments, each of the entries in the mapping database 225 is compared with the received device identifier to determine whether there is a match. Also, in some embodiments, the mapping database 225 may be structured so that it can be quickly or efficiently searched to determine if the received device identifier is already stored in it. For example, a particular portion of the mapping database 225 may be designated for storing the device identifiers so that only that portion would be searched to determine if the received device identifier is stored there. Additionally, or alternatively, the data of the mapping database 225 may be sorted in a specific order (e.g., in alphabetical order) to assist in efficiently searching for matching device identifiers.

Further, step 302 may be designed to search for an exact match or a partial match. For example, where step 302 searches for exact matches, a match for the received device identifier of “Gate Sensor 1” would require finding “Gate Sensor 1” from among the data in the mapping database 225. In comparison, where step 302 searches for partial matches, the PLC 101 may determine that a match is found if the received device identifier is “Gate Sensor 1” and the mapping database includes a device identifier of “Gate Sensor One.” Various parameters may be set by a user at the time of designing the PLC 101 or at any other time thereafter to determine the conditions under which step 302 should identify a match. If a match is determined in step 302 (Yes at step 302), the process of FIG. 3 proceeds to step 303.

Step 303 determines whether the matching device identifier in the mapping database 225 has a corresponding network address. As mentioned above, the mapping database 225 may store device identifiers and corresponding network addresses. The mapping database 225 may be structured in various manners as long as when one piece of information from among the device identifier and network address are identified, the other piece of information corresponding to the identified piece of information can be located if it exists. For example, the device identifier may be stored along with a pointer to a memory address that includes the corresponding network address. Alternatively, the device identifier and network address may be stored together in a single packet which is defined such that it is known that certain bits represent the device identifier while other bits of the packet represent the network address.

If a corresponding network address for the matching device identifier is detected in step 303 (Yes at step 303), then the process of FIG. 3 may end. In a case where the process of FIG. 3 ends after step 303, the received identifier may be disposed of without being added to the mapping database 225. In some embodiments, instead of terminating the process, the received device identifier may be assigned a new device identifier at step 304. It should be understood that whether step 304 is performed depends on the particular embodiment. Where a new device identifier is assigned in step 304, the newly assigned device identifier may be selected based upon a preset algorithm. That is, step 304 may automatically add an alphanumeric character, increase an alphanumeric character, or add a timestamp to the received device identifier. For example, where the received device identifier is “Gate Sensor 1,” step 304 may change it to “Gate Sensor 2” or Gate Sensor 1B.” Alternatively, step 304 may prompt a user to enter a new device identifier through an input device 215. That is, step 304 may display an error message on a display 217 of the PLC 101 indicating that the received device identifier was already in the mapping database 225 and requesting a new device identifier. The message displayed may even suggest possible device identifiers similar to those that might be automatically generated as described above.

Further, step 304 may communicate the new device identifier to the device (e.g., an I/O device 105) that sent the received device identifier. In some automation networks 100, it may be desired that the devices (e.g., I/O devices 105) also store their device identifiers. Thus, it may be desired that the changes made in step 304 be communicated back to the appropriate devices.

Returning to step 302, if a matching device identifier is not found in the mapping database 225 (No at step 302), then the process proceeds to step 305. In step 305, the device identifier is stored in the mapping database 225. Depending on the particular embodiment, the device identifier may be stored at a particular memory address. In some embodiments, the device identifier may be encrypted or compressed before storing.

After step 305 is completed, step 304 is completed, or when no corresponding network address is determined for a matching device identifier (No at step 303), the process of FIG. 3 proceeds to step 306. In step 306, a network address corresponding to the received device identifier is received. In some embodiments, the network address may be received at the same time or even before the device identifier is received. Regardless, as shown in FIG. 3, the network address still might not be evaluated until after the received device identifier exists in the mapping database 225.

The network address received in step 306 may be received in a manner such that it is clear which device identifier it corresponds to. In some embodiments, the network address may be included in a packet of data having both the network address and the corresponding device identifier.

Then, in step 307, the network address may be analyzed to determine whether it exists in the mapping database 225. In some embodiments, each device may have its own network address. In such cases, step 307 is performed to search the mapping database 225 to make sure that another device identifier is not associated with the received network address. If the received network address is determined to already exist in the mapping database 225 (Yes at step 307), then the process of FIG. 3 may end. In the case where the process ends after step 307, the received device identifier and received network address may be discarded without being added to the mapping database 225. Accordingly, the device identifier stored in step 305 of the same instance of the process in FIG. 3 may be erased.

In some embodiments, instead of terminating the process, the received network address may be modified or replaced with a new network address at step 308. It should be understood that whether step 308 is performed depends on the particular embodiment. The new network address created in step 308 may be determined based upon a preset algorithm. That is, step 308 may automatically generate a network address or may select from a list of available network addresses stored in, or accessible by, the PLC 101. In some embodiments, the PLC 101 may use a DHCP server and/or a DNS server to resolve and/or allocate the IP address. Alternatively, step 308 may prompt a user to enter a new network address through an input device 215. That is, step 308 may display an error message on a display 217 of the PLC 101 indicating that the received network address was already in the mapping database 225 and requesting a new network address. The message displayed may even suggest possible network addresses from a list of possible network addresses stored in, or accessible by, the PLC 101.

Further, step 308 may communicate the new network address to the device (e.g., an I/O device 105) that sent the received network address. In some automation networks 100, it may be desired that the devices (e.g., I/O devices 105) also store their network addresses. Thus, it may be desired that the changes made in step 308 be communicated back to the appropriate devices.

After step 308 is completed or when no matching network address is found (No at step 307), the process of FIG. 3 proceeds to step 309. In step 309, the PLC 101 stores the network address with its corresponding device identifier.

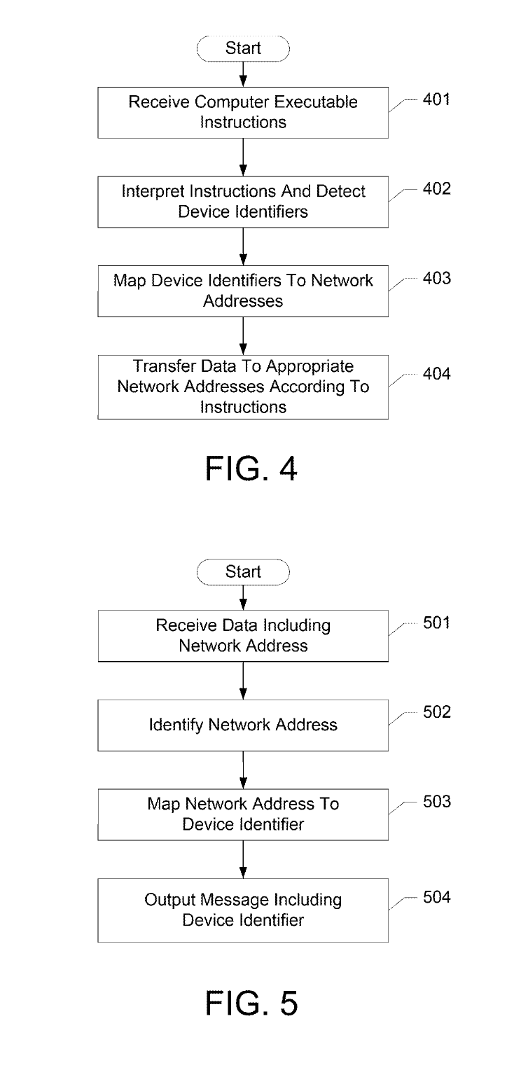

FIG. 4 illustrates a flow diagram of an example process in accordance with aspects of the present disclosure. More specifically, FIG. 4 shows a process by which a PLC 101 may communicate with I/O devices 105. Thus, the steps of FIG. 4 may be performed by the PLC 101 under the direction of a control application.

The process of FIG. 4 begins with step 401 in which computer-executable instructions (e.g., a computer program) are received by the PLC 101. The computer-executable instructions may be inputted into the PLC 101 via the input device 215 and/or a host computing device/human machine interface 113. Herein, the computer-executable instructions may be written in any programming language, such as BASIC, C, Java, Ladder Logic, a proprietary automation control network language, etc. The instructions control the PLC 101 to communicate with the I/O devices 105. For example, the instructions may cause the PLC 101 to activate certain I/O devices 105 at certain times or in accordance with certain patterns. Also, the instructions may control how the PLC 101 responds to certain information received from the various I/O devices 105.

In step 402, the computer-executable instructions may be interpreted by the PLC 101 using the processor 201. The PLC 101 may be configured to interpret the computer-executable instructions to detect device identifiers within the computer-executable instructions. Specifically, the computer-executable instructions may be parsed to determine which instructions refer to device identifiers. Because the computer-executable instructions may refer to meaningful device identifiers instead of abstract network addresses when referencing various network devices within an automation control network, programming/implementation may become more intuitive/efficient and mistakes associated with using network addresses may be avoided.

The device identifiers detected in step 402 are translated into network addresses in step 403. In particular, the mapping database 225 may be used to translate the device identifiers into network addresses. Step 403 may perform a search of the mapping database 225 for the detected device identifiers, and return the network addresses corresponding to matching device identifiers.

In some embodiments, a device identifier may have multiple corresponding network addresses. For example, a device identifier may have an IPv4 address, an IPv6 link local address, and an IPv6 Global address. Where multiple corresponding network addresses exist in the mapping database 225 for the device identifier, step 402 may return one or more of the corresponding network addresses. Thus, the PLC 101 may translate the device identifier to only one network address or to multiple network addresses.

Next, in step 404, data are sent to the I/O devices 105 having the network addresses returned in step 403. That is, the PLC 101 may generate a packet (e.g., an IPv4 or IPv6 packet) containing payload information and addressed to the network address identified in step 403. The PLC 101 may determine what payload information is to be sent to which I/O devices 105 according to the computer-executable instructions. The payload information may be data that instructs the I/O device to perform a function. For example, where a particular I/O device is a motor starter, the PLC 101 may send data instructing the motor starter to turn on a motor.

FIG. 5 illustrates a flow diagram of an example process in accordance with aspects of the present disclosure. More specifically, FIG. 5 shows a process by which a PLC 101 may communicate with I/O devices 105. Thus, the steps of FIG. 5 may be performed by the PLC 101 under the direction of a control application.

The process of FIG. 5 begins with step 501 in which the PLC 101 may receive data from an I/O device 105. The data received may include information collected by the I/O device 105 (e.g., temperature, pressure, etc.), a state of the I/O device 105 (e.g., an on-state, an off-state, a stand-by state, an out-of-order state, etc.), and/or an alert or notification signal. For example, where the I/O device 105 is a gate sensor, the gate sensor may send an alert signal each time the gate sensor detects an object. Also, the data received in step 501 may further include a network address identifying the I/O device 105 that sent the data. For example, where multiple gate sensors are connected to the same PLC 101 and the PLC 101 receives an alert signal, the data may also include a network address so that the PLC 101 can determine which gate sensor provided the alert signal.

The network interface 211 may send the data received in step 501 to the processor 201 of the PLC 101. The processor 201 may then decode the data to determine the network address from the remainder of the data. Where the data is, for example, a TCP packet, the processor 201 may extract the IP address from the header of the packet.

The network address decoded in step 502 may be mapped to determine the corresponding device identifier in step 503. More specifically, the processor 201 may use the mapping database 225 to detect the network address matching the decoded network address, and then extract the device identifier corresponding to the detected network address from the mapping database 225. Thus, the processor 201 with the assistance of the mapping database 225 may translate the network address into a device identifier.

After obtaining the corresponding device identifier, the PLC 101 may output a message depending on the data and identifying the message as being provided by the device identifier in step 504. The message may be outputted by displaying the message on the display 217 or another display or by playing an audible message. For example, the PLC 101 may output a message explaining that an undesirably high temperature was detected by the temperature sensor having the “Front Temperature Sensor” device identifier. Thus, a user of the PLC 101 may identify which I/O device 105 is responsible for the displayed message. Because the device identifier may be a meaningful name, the I/O device 105 may be more easily identified from the device identifier than from the network address.

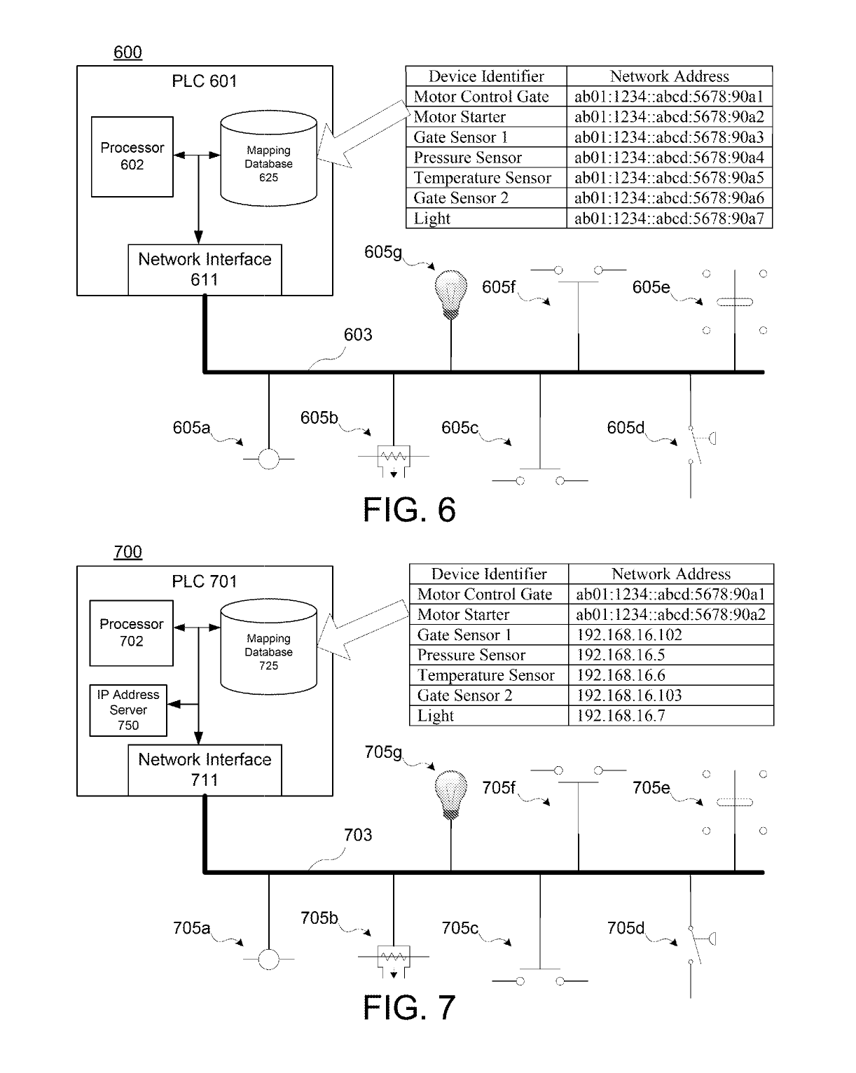

FIG. 6 is a high level diagram illustrating a configuration of an example automation network 600 in accordance with an aspect of the present disclosure. The example automation network 600 in FIG. 6 includes a PLC 601, a data bus 603, and I/O devices 605. As shown in FIG. 6, the PLC 601 may include a processor 602, a network interface 611, and a mapping database 625, while the I/O devices 605 may include a motor control gate 605a, a motor starter 605b, a first gate sensor (Gate Sensor 1) 605c, a pressure sensor 605d, a temperature sensor 605e, a second gate sensor (Gate Sensor 2) 605f, and a light 605g.

The automation network 600 may use the Devices Profile for Web Services (DPWS) functionality with the IPv6 protocol. In the automation network 600, each I/O device 605 may determine its own link local IPv6 address based on its MAC address and attaches the well-known prefix “fe80::” as defined in the RFC 2462 specification. The I/O devices 605 may determine their own link local IPv6 addresses in response to a power-up of the automation network 600, an initial incorporation of the I/O device 605 into the automation network, and/or a reinstallation of the I/O device 605.

When the automation network 600 is powered-up, a control application executed by the processor 602 of the PLC 601 may initiate DPWS auto discovery (via WS-discovery and WS-MetadataExchange) to discover each of the device identifiers and IPv6 addresses of I/O devices 605. In DPWS auto discovery, the PLC 601 broadcasts a request over the data bus 603 so that each I/O device 605 connected to the data bus 603 receives the request. Then, in response to the request, each of the I/O devices 605 provides its device identifier and IPv6 address to the PLC 601. The PLC 601 enters the received device identifiers and IPv6 addresses into the mapping database 625.

Subsequently, if the PLC 601 wishes to send instructions to specific I/O devices 605, the PLC 601 may scan the mapping database 625 to identify the corresponding IPv6 address for the specific I/O devices 605 and generate IPv6 packets with the identified addresses and appropriate instructions. Accordingly, a user of the PLC 601 does not need to enter the IPv6 addresses into program instructions. Rather, the user may provide program instructions to the PLC 601 that simply refer to the device identifier that it intends to operate.

In the event that an I/O device 605 is replaced (e.g., due to device failure, an upgrade, etc.), the new device may be inserted without disrupting the automation network 600. The new I/O device 605 may be configured with the same device identifier as the device that it is replacing and connected to the automation network 600. Once connected, the new I/O device 605 may send a DPWS Hello message automatically notifying the PLC 601 of its new IPv6 address. In one or more arrangements, the DPWS Hello message may include additional information, such as the device identifier of the new I/O device 605 from which it is sent. However, in other arrangements, the PLC 601 may proceed with a process for retrieving metadata from the new I/O device 605 (e.g., may implement WS-MetadataExchange). Upon receiving the notification, the PLC 601 may update the mapping database 625 to include the new IPv6 address corresponding to the device identifier. Accordingly, the PLC 601 may continue to run, and thus, does not have to be restarted. Further, the mapping database 625 does not have to be manually configured to include the new IPv6 address.

In some cases, the PLC 601 may also be replaced (e.g., due to device failure, an upgrade, etc.). When a new PLC 601 is connected to the automation network 600, the new PLC may perform DPWS auto discovery to discover each of the I/O devices 605 in the automation network 600 and populate its own mapping database 625. Accordingly, it may not be necessary to power-cycle the automation network 600. That is, the I/O devices 605 may remain in an on-state while the PLC 601 is replaced.

Although the above example use case is described as using the IPv6 protocol with DPWS auto discovery, this is not necessarily the case. In some embodiments, where each of the I/O devices 605 in the automation network 600 has a link-local IPv4 address as defined in RFC 3927, DPWS auto discovery may also be used to configure the IP addresses. That is, DPWS auto discovery may be used in the automation network 600 of FIG. 6 even if I/O devices 605 cannot support the IPv6 protocol, so long as every I/O device 605 in the automation network 600 has a link-local IPv4 address.

FIG. 7 is a high level diagram illustrating a configuration of another example automation network 700 in accordance with an aspect of the present disclosure. The example automation network 700 in FIG. 7 includes a PLC 701, a data bus 703, and I/O devices 705. As shown in FIG. 7, the PLC 701 may include a processor 702, a network interface 711, a mapping database 725, and an IP address server 750. Although the IP address server 750 is shown in the same structure of the PLC 701, the IP address server 750 may be external to the PLC 701 so long as it is connected to the PLC 701. Meanwhile, the I/O devices 705 may include a motor control gate 705a, a motor starter 705b, a first gate sensor (Gate Sensor 1) 705c, a pressure sensor 705d, a temperature sensor 705e, a second gate sensor (Gate Sensor 2) 705f, and a light 705g.

The automation network 700 may use the Devices Profile for Web Services (DPWS) functionality with the IPv4 or IPv6 protocol. In the automation network 700, one or more I/O devices 705 may determine their own IPv4 address or link local IPv6 address based on their own MAC address and may attach the well-known prefix “fe80::” as defined in RFC 2462. These I/O devices 705 that support DPWS discovery may determine their own IPv4 address or link local IPv6 address in response to a power-up of the automation network 700, an initial incorporation of the I/O device 705 into the automation network, and a reinstallation of the I/O device 705. Further, one or more other I/O devices 705 in the same automation network 700 might not have DPWS discovery capability. These I/O devices 705 may instead acquire their IPv4 address or IPv6 address from the IP address server 750 on the automation network 700. That is, these I/O devices 705 may use the dynamic host configuration protocol (DHCP) to determine their IP address. More specifically, I/O devices 705 that are not able to perform DWPS discovery may send a DHCP request to the IP address server 750 (e.g., a DHCP server), which may assign an IP address to the requesting I/O device 705. Further, the IP address server 750 may also communicate with the PLC 701 so that the mapping database 725 may be populated with the assigned IP addresses as well. For example, the IP address server 750 may directly communicate with the processor 702 of the PLC 701, which then updates the mapping database 725. In some arrangements, the IP address server 750 may send the IP address to the requesting I/O device 705 which subsequently transmits the IP address to the mapping database 725. Additionally, or alternatively, the processor 702 of the PLC 701 may poll the IP address server 750 to determine changes in the assigned IP addresses and update the mapping database 725 accordingly. The processor 702 may poll the IP address server 750 periodically (e.g., according to a predefined time period) or in response to an event, such as when the network interface 711 receives data (e.g., a DHCP request or DPWS Hello message). Thus, by various processes, the mapping database 725 may receive device identifiers and corresponding IPv4 or IPv6 addresses from all I/O devices 705 whether they use DPWS discovery or DHCP requests.

In some embodiments, the PLC 701 may control the IP address server 750 to wait until after IP addresses from the DPWS discovery enabled devices are received. In this manner, the PLC 701 may prevent or reduce the likelihood that the IP address server 750 assigns a duplicate IP address.

When the PLC 701 wishes to send instructions to specific I/O devices 705, the PLC 701 may scan the mapping database 725 to identify the corresponding IPv4 or IPv6 address for the specific I/O devices 705 and generate IPv4 or IPv6 packets with the identified addresses and appropriate instructions. Whether the PLC 701 communicates with a particular I/O device 705 over IPv4 or IPv6 depends on whether an IPv4 or IPv6 address is in the mapping database 725.

If an I/O device 705 is replaced (e.g., due to device failure, an upgrade, etc.), the new device may be inserted without disrupting the automation network 700. The new I/O device 705 may be configured with the same device identifier as the device that it is replacing and connected to the automation network 700. Once connected, the I/O devices 705 having DPWS discovery capability may transmit a DPWS Hello message. The remaining I/O devices 705 that do not have DPWS discovery capability may send a DHCP request to the IP address server 750 for a new IP address or the IP address used previously by a removed device having the same device identifier. Whether the new I/O device 705 has DPWS discovery capability or not, the mapping database 725 may be updated to include the new IP address or the IP address used previously by a removed device having the same device identifier. Also, the PLC 701 may continue to run while the I/O device 705 is replaced and the mapping database 725 is updated.

The PLC 701 may also be replaced. If all of the I/O devices 705 in the automation network 700 have DPWS discovery capability, then a new PLC 701 can be inserted without having to power-cycle the automation network 700. However, if one or more of the I/O devices 705 in the automation network 700 utilize DHCP to ascertain their IP address and do not have DPWS discovery capability, then the automation network 700 may be power-cycled before the new PLC 701 begins to operate correctly. Alternatively, if the mapping database 725 remains unmodified or if the information from the mapping database 725 of the removed PLC 701 is transferred to the new PLC 701, then the automation network 700 might not be power-cycled.

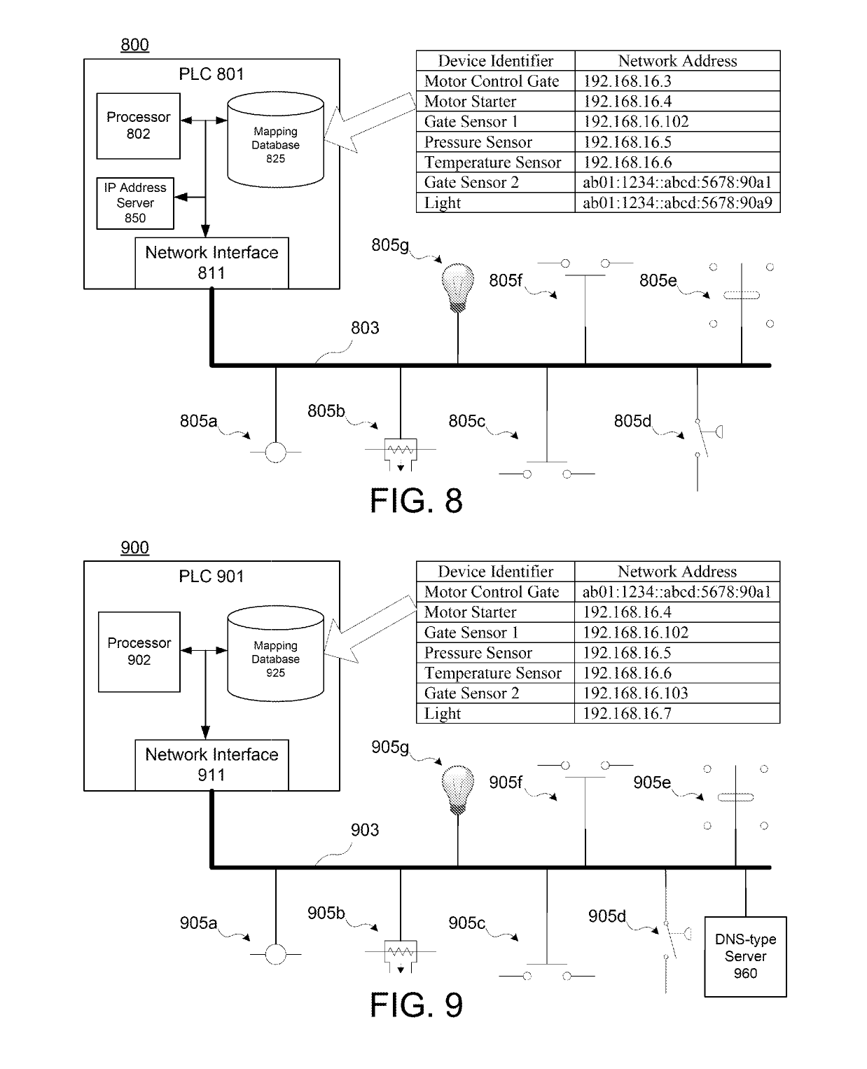

FIG. 8 is a high level diagram illustrating a configuration of yet another example automation network 800 in accordance with an aspect of the present disclosure. The example automation network 800 in FIG. 8 includes a PLC 801, a data bus 803, and I/O devices 805. As shown in FIG. 8, the PLC 801 may include a processor 802, a network interface 811, a mapping database 825, and an IP address server 850. Although the IP address server 850 is shown in the same structure of the PLC 801, the IP address server 850 may be external to the PLC 801 so long as it is connected to the PLC 801. Meanwhile, the I/O devices 805 may include a motor control gate 805a, a motor starter 805b, a first gate sensor (Gate Sensor 1) 805c, a pressure sensor 805d, a temperature sensor 805e, a second gate sensor (Gate Sensor 2) 805f, and a light 805g.

In the example automation network 800 of FIG. 8, each of the I/O devices 805 may acquire their IP addresses using DHCP. In particular, DHCP option 12 requests may be made by each of the I/O devices 805 to retrieve their respective IP address from the IP address server 850. The IP address server 850 may assign IP addresses sequentially or using algorithms so that each of the I/O devices are assigned a unique IP address. Moreover, each of the I/O devices 805 may only communicate over IPv4. As IP addresses are assigned to each of the I/O devices 805, the mapping database 825 may store device identifiers with their corresponding IP addresses. Thus, the PLC 801 may scan the mapping database 825 to identify appropriate IP addresses for specific I/O devices 805 to which it intends to send instructions.

In the event that an I/O device 805 is replaced (due to device failure, an upgrade, etc.), a new device may be configured to have the same device identifier and may be placed in the automation network 800. Upon being connected to the automation network 800, the new I/O device may transmit a DHCP request with its device identifier. The IP address server 850 may be able to assign the new I/O device 805 the same IP address as the old I/O device 805 in which case the mapping database does not have to be updated. Alternatively, in response to receiving the DHCP request from the new I/O device 805, the IP address server 850 may assign a new IP address to the new I/O device 805. In this case, the mapping database 825 may be updated to include the new IP address corresponding to the device identifier of the new I/O device 805. In some cases, the IP address server 850 may send the new IP address directly to the mapping database 825, while in other cases the mapping database 825 may be updated in response to a communication received from the new I/O device.

The PLC 801 may also be replaced. When each of the I/O devices 805 in the automation network 800 utilize DHCP to ascertain their IP address (i.e., do not have DPWS discovery capability), then the automation network 800 may be power-cycled before the new PLC 801 begins to operate correctly. However, if the mapping database 825 remains unmodified or if the information from the mapping database 825 of the removed PLC 801 is transferred to the new PLC 801, then the new PLC 801 may be inserted into the automation network 800 without having to power-cycle the network including the I/O devices 805.

FIG. 9 is a high level diagram illustrating a configuration of still another example automation network 900 in accordance with an aspect of the present disclosure. The example automation network 900 in FIG. 9 includes a PLC 901, a data bus 903, I/O devices 905, and a DNS server 960. Although the server 960 is referred to as a “DNS server,” it should be understood that the DNS server 960 may also be implemented as a Windows Internet Name Service (WINS) server or another server which can perform functions similar to a DNS server. As shown in FIG. 9, the PLC 901 may include a processor 902, a network interface 911, and a mapping database 925. Although the DNS server 960 is shown in a separate structure from the PLC 901, the DNS server 960 may be internal to the PLC 901. Meanwhile, the I/O devices 905 may include a motor control gate 905a, a motor starter 905b, a first gate sensor (Gate Sensor 1) 905c, a pressure sensor 905d, a temperature sensor 905e, a second gate sensor (Gate Sensor 2) 905f, and a light 905g.

In the example automation network 900, each of the I/O devices 905 may acquire their IP addresses from the DNS server 960. In some embodiments, the I/O devices 905 may be configured with temporary IP addresses. The temporary IP addresses may be used for initial communications with the DNS server 960, and may include, for example, a net IP address (e.g., IP address with leading zeros), which only allows the I/O device 905 to communicate to devices within a subnet of the automation network 900, or an IP address based on a MAC address. Also, in sending a request for an IP address, each of the I/O devices 905 may specify its full path name (e.g., a full URL). Once the DNS server 960 receives the request, it may assign the I/O device 960 a new IP address and inform the I/O device 905 of its new IP address so that it may replace the temporary IP address. The DNS server 960 may include device identifiers and their respective IP addresses for each of the I/O devices 905. The DNS server 960 may be filled by any means including manually entering device identifiers and corresponding IP addresses.

Upon powering-up, the PLC 901 may populate the mapping database 925 with the information stored in the DNS server 960. Therefore, both the mapping database 925 and the DNS server 960 may contain the device identifiers and their corresponding IP addresses for each of the I/O devices 905. While the mapping database 925 and DNS server 960 may store similar information, they may have separate functions. The DNS server 960 may be used to push IP addresses to the I/O devices 905, whereas the mapping database 925 may be used by the PLC 901 to translate communications with the various I/O devices 905 to allow users to interface with the PLC 901 using device identifiers. For example, the PLC 901 may send instructions to specific I/O devices 905 by scanning the mapping database 925 to identify corresponding IPv4 addresses for the specific I/O devices 905.

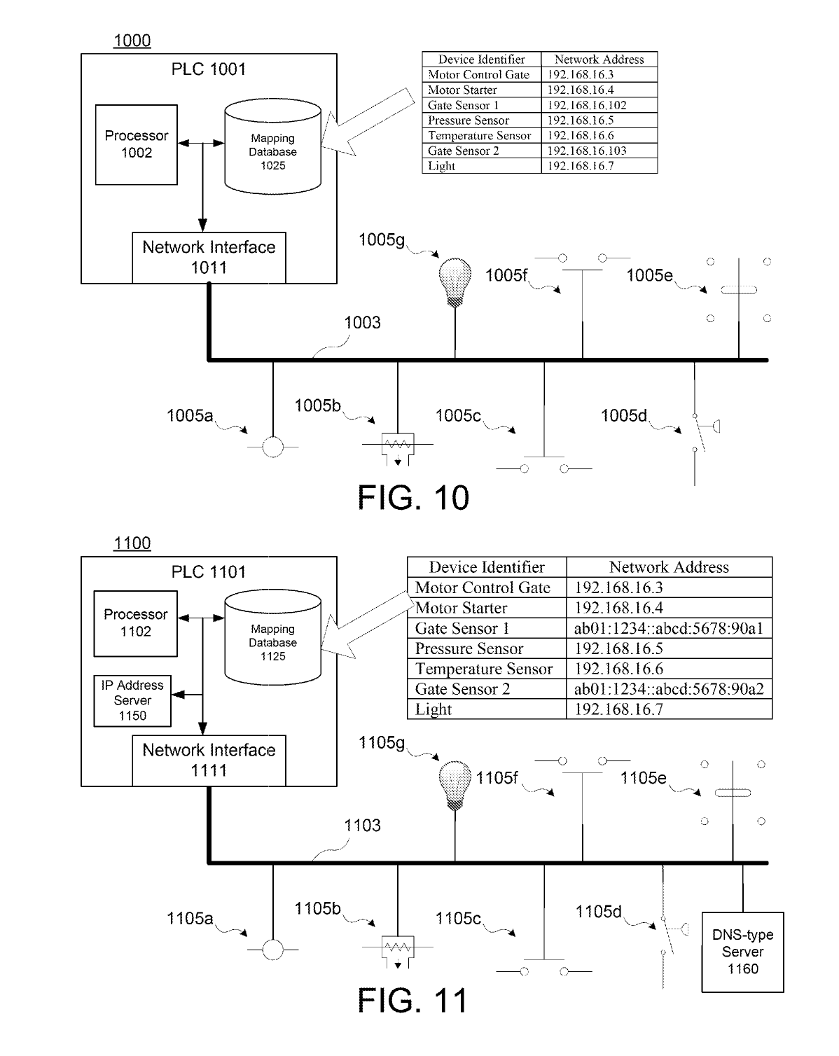

FIG. 10 is a high level diagram illustrating a configuration of still another example automation network 1000 in accordance with an aspect of the present disclosure. The example automation network 1000 in FIG. 10 includes a PLC 1001, a data bus 1003, and I/O devices 1005. As shown in FIG. 10, the PLC 1001 may include a processor 1002, a network interface 1011, and a mapping database 1025, while the I/O devices 1005 may include a motor control gate 1005a, a motor starter 1005b, a first gate sensor (Gate Sensor 1) 1005c, a pressure sensor 1005d, a temperature sensor 1005e, a second gate sensor (Gate Sensor 2) 1005f, and a light 1005g.

Each of the I/O devices 1005 may be configured with a device identifier and static IP address. Here, a static IP address is an assigned IP address that is only used for the particular I/O device 1005 and is the same each time the I/O device 1005 is powered-up. In other words, each of the I/O devices 1005 may have its own IP address and that address remains with that I/O device 1005 even after the I/O device 1005 is powered-down. With knowledge of the static IP addresses for each of the I/O devices 1005, a user may configure the mapping database 1025 to include device identifiers and the appropriate static IP addresses. Specifically, a user may enter each of the device identifiers and static IP addresses into the mapping database 1025. As a result, the PLC 1001 may send instructions to specific I/O devices 1005 by scanning the mapping database 1025 to identify corresponding static IP addresses for the specific I/O devices 1005.

When a new I/O device 1005 is inserted into the automation network 1000 to replace a previous I/O device 1005, the new I/O device 1005 may be given the same device identifier and static IP address as the previous I/O device 1005. Alternatively, the new I/O device 1005 may be assigned a new device identifier and/or static IP address and the mapping database 1005 may be updated accordingly.

When a new PLC 1001 is inserted into the automation network 1000 to replace a previous PLC 1001, the mapping database 1025 of the new PLC 1001 may be configured to include the same information as the mapping database 1025 of the previous PLC1001. That is, the device identifiers and static IP addresses may be entered into the mapping database 1025 of the new PLC 1001, so that the new PLC 1001 may be seamlessly inserted into the automated network 1000 without having to power cycle the network.

FIG. 11 is a high level diagram illustrating a configuration of still another example automation network 1100 in accordance with an aspect of the present disclosure. The example automation network 1100 in FIG. 11 includes a PLC 1101, a data bus 1103, I/O devices 1105, and a DNS server 1160. As shown in FIG. 11, the PLC 1101 may include a processor 1102, a network interface 1111, a mapping database 1125, and an IP address server 1150. Accordingly, the embodiment of FIG. 11 illustrates that both a DNS server 1160 external to the PLC 1101 and the IP address server 1150 (e.g., a DHCP server) internal to the PLC 1101 may update the mapping database 1125.

The I/O devices 1105 may include a motor control gate 1105a, a motor starter 1105b, a first gate sensor (Gate Sensor 1) 1105c, a pressure sensor 1105d, a temperature sensor 1105e, a second gate sensor (Gate Sensor 2) 1105f, and a light 1105g. Each of the I/O devices 1105 may be configured with a device identifier and one or more IP addresses. The IP addresses of each I/O device 1105 may be IPv4 and/or IPv6 addresses. In this example embodiment, the IP addresses may be determined by any method including static allocation, dynamic allocation (e.g., using a DNS server or DHCP server), and/or auto-configuration (e.g., using DPWS discovery). That is, the IP addresses of the I/O devices 1105 may be determined by DPWS discovery with respect to those I/O devices 1105 that support DPWS discovery, with the assistance of the IP address server 1150, with the assistance of the DNS server 1160, and/or by manually entering static IP addresses. Subsequently, each I/O device 1105 may utilize the Address Resolution Protocol (ARP) to ensure it does not have the same IP address as another I/O device 1105 in the network. In particular, an ARP probe and/or an ARP announce message (e.g., a gratuitous ARP message) may be transmitted by the I/O devices 1105 to resolve IP address conflicts when the PLC 1101 is powered-up or when it is otherwise available to communicate with the I/O devices 1105. Additionally, or alternatively, a learning algorithm of the IP Address Server 1150 (e.g., a learning algorithm of a DHCP server) may prevent the same IP addresses from being used for different I/O devices 1105.

In some embodiments, each I/O device 1105 may support the Link-Local Multicast Name Resolution (LLMNR) Protocol or Multicast DNS (mDNS) Protocol. After all the multicast requests are sent and each of the I/O devices 1105 have determined their IP addresses, the mapping database 1125 may be updated with the IP addresses received from the I/O devices 1105. Thus, the mapping database 1125 may store at least one unique IP address and device identifier for each I/O device 1105 in the automation network 1100. So, when the PLC 1101 communicates with the I/O devices 1105, it may use the mapping database 1125 to translate device identifiers into IP addresses and vice versa.

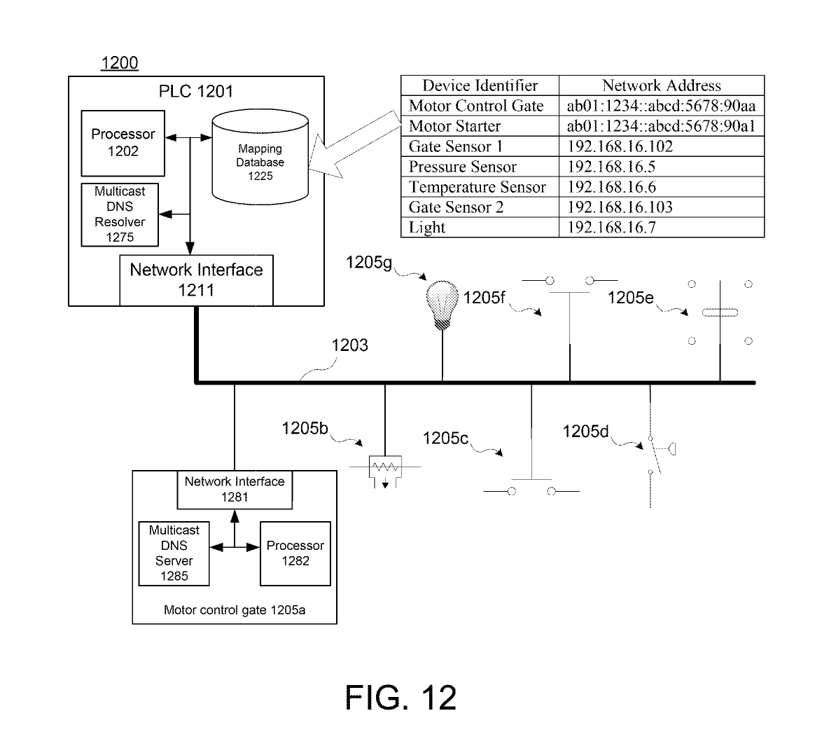

FIG. 12 is a high level diagram illustrating a configuration of still another example automation network 1200 in accordance with an aspect of the present disclosure. The example automation network 1200 in FIG. 12 includes a PLC 1201, a data bus 1203, and I/O devices 1205. As shown in FIG. 12, the PLC 1201 may include a processor 1202, a network interface 1211, a mapping database 1225, and a multicast DNS resolver 1275. The I/O devices 1205 may include a motor control gate 1205a, a motor starter 1205b, a first gate sensor (Gate Sensor 1) 1205c, a pressure sensor 1205d, a temperature sensor 1205e, a second gate sensor (Gate Sensor 2) 1205f, and a light 1205g. Further, each of the I/O devices 1205 may include a network interface 1281, a processor 1282, and a multicast DNS (mDNS) server 1285 (for convenience, only the motor control gate 1205a is shown with such features). In some embodiments, the mDNS server 1258 (e.g., mDNS responder) might be complemented with an mDNS resolver in each I/O device 1205. Such configuration may enable direct and decentralized “name/IP address” resolution between I/O devices 1205.

Each of the I/O devices 1205 may be configured with a device identifier and one or more IP addresses. The IP addresses of each I/O device 1205 may be IPv4 and/or IPv6 addresses. In this example embodiment, the IP addresses may be determined by any method including static allocation, dynamic allocation (e.g., using a DHCP server), and/or auto-configuration (e.g., using IPv6 Stateless Address Autoconfiguration per RFC 4862 or using auto-configuration of the IPv4 address per RFC 3927).

The IP addresses of the I/O devices 1205 may be determined by multicasting DNS requests including the identifier of the targeted I/O device 1205 on a local sub-network using, for example, the LLMNR protocol per RFC 4795 or the mDNS protocol per http://tools.ietforg/html/draft-cheshire-dnsext-multicastdns-15. The I/O device 1205 matching the specified identifier and supporting the corresponding DNS responder (e.g., LLMNR or mDNS responder) will answer the request. Using multicast DNS-type protocols avoids the need for deploying a centralized DNS architecture. In light of the responses, the PLC 1201 updates the mapping database 1225 with new IP addresses received from the I/O devices 1205. Thus, the mapping database 1225 may store at least one unique IP address and device identifier for each I/O device 1205 in the automation network 1200. So, when the PLC 1201 communicates with the I/O devices 1205, it may use the mapping database 1225 to translate device identifiers into IP addresses and vice versa. To speed-up detection of a new I/O device 1205 and to quickly update the mapping database 1225 with accurate information upon start-up (or power-up) or modification of the IP address of an I/O device 1205, I/O devices 1205 may implement an “Announcing” protocol similar to or inspired from processes described in section “8. Probing and Announcing on Startup” of the mDNS protocol specification. Further, to resolve potential device identifier or IP address conflicts, I/O devices 1205 may implement conflict resolution mechanisms similar to or inspired from processes described in section “8. Probing and Announcing on Startup” and section “9. Conflict Resolution” of the mDNS protocol specification.

Aspects of the invention have been described in terms of illustrative embodiments thereof Numerous other embodiments, modifications, and variations within the scope and spirit of the appended claims will occur to persons of ordinary skill in the art from a review of this disclosure. For example, one of ordinary skill in the art will appreciate that the steps illustrated in the illustrative figures may be performed in other than the recited order, and that one or more steps illustrated may be optional in accordance with aspects of the invention.

What is claimed is:

1. A non-transitory computer-readable storage medium having computer-executable program instructions stored thereon that when executed by a processor, cause the processor to perform steps comprising:
receiving, via a data bus, data from at least one of a plurality of input/output (I/O) devices;
identifying a network address from among the received data;
mapping the identified network address to determine a corresponding device identifier using a database, wherein the database is configured to store a plurality of device identifiers and at least one corresponding network address for each of the plurality of I/O devices; and
outputting a message including the determined device identifier.

2. The non-transitory computer-readable storage medium of claim 1, wherein the determined device identifier comprises an alphanumeric string descriptive of a function associated with one of the plurality of I/O devices, and wherein each of the I/O devices is one of a sensor, actuator, light, and motor.

3. The non-transitory computer-readable storage medium of claim 1, wherein the processor further performs:
receiving a first device identifier from a first input/output (I/O) device from among the plurality of I/O devices;
determining whether the first device identifier is stored in the database;
receiving a first network address from the first I/O device;
determining whether the first network address is stored in the database; and
storing the first network address in association with the first device identifier in the database if the first network address is not stored in the database.

4. The non-transitory computer-readable storage medium of claim 3, wherein the processor further performs:
transmitting one or more Devices Profile for Web Services (DPWS) discovery requests via the data bus,
wherein the first device identifier and first network address are received in response to the DPWS discovery request.

5. The non-transitory computer-readable storage medium of claim 3, wherein the first network address received from the first I/O device is assigned to the first I/O device by an Internet Protocol (IP) address server.

6. The non-transitory computer-readable storage medium of claim 5, wherein the IP address server is a Dynamic Host Configuration Protocol (DHCP) server.

7. The non-transitory computer-readable storage medium of claim 5, wherein the processor further performs:
receiving a second device identifier from a second input/output (I/O) device from among the plurality of I/O devices;
determining whether the second device identifier is stored in the database;
receiving a second network address from the second I/O device;
determining whether the second network address is stored in the database; and
storing the second network address in association with the second device identifier in the database if the second network address is not stored in the database,
wherein the second network address received from the second I/O device is assigned to the second I/O device by a Domain Name Server (DNS).

8. The non-transitory computer-readable storage medium of claim 3, wherein the first network address received from the first I/O device is assigned to the first I/O device by a Domain Name Server (DNS).

9. The non-transitory computer-readable storage medium of claim 3, wherein the first network address is one of an Internet Protocol version 4 (IPv4) address and an Internet Protocol version 6 (IPv6) address.

10. An apparatus, comprising:
a database;
a processor; and
memory storing computer-executable instructions that, when executed by the processor, cause the apparatus to:
receive at least one device identifier and at least one address corresponding to each of the at least one device identifier;
store the at least one device identifier and the corresponding at least one address in the database;
receive data inputted through a user device;
compare at least a first portion of the inputted data with the at least one device identifier stored in the database to detect a matching device identifier;
search the database to identify an address corresponding to the matching device identifier; and
transfer operation data according to instructions included in a second portion of the inputted data to the identified address.

11. The apparatus of claim 10, wherein the memory stores additional computer-executable instructions that, when executed, cause the apparatus to interpret the inputted data to detect that the first portion of the inputted data includes a device identifier,
wherein each of the device identifiers is a descriptive alphanumeric string identifying a respective device.

12. The apparatus of claim 10, wherein the transferring of the operation data comprises:
generating a packet having the identified address; and
transmitting the packet over a data bus.

13. The apparatus of claim 10, wherein each of the at least one address are one of an IPv4 address and an IPv6 address.

14. The apparatus of claim 10, further comprising an IP address server configured to assign the at least one address to an I/O device.

15. The apparatus of claim 10, wherein the memory stores additional computer-executable instructions that, when executed, cause the apparatus to:
receive one or more multicast requests from a plurality of I/O devices; and
resolve names for the plurality of I/O devices.

16. A method, comprising:
receiving computer-executable instructions;
interpreting the computer-executable instructions to determine a first device identifier;
translating the first device identifier into a first address; and
transmitting data to a first device associated with the first address.

17. The method of claim 16, wherein the translating of the first device identifier into the first address comprises:
searching a database to detect a device identifier matching the first device identifier determined from the computer-executable instructions; and
searching the database to identify an address corresponding to the detected device identifier.

18. The method of claim 16, wherein the transmitting of data to the first device associated with the first address comprises:
generating a packet having the first address; and
transmitting the packet over a data bus.

19. The method of claim 16, further comprising:
interpreting the computer-executable instructions to determine a second device identifier;
translating the second device identifier into a second address; and
transmitting data to a second device associated with the second address,
wherein the first address includes an Internet Protocol version 4 (IPv4) address and the second address includes an Internet Protocol version 6 (IPv6) address.

20. The method of claim 16, further comprising:
receiving the first device identifier and the first address from the first device;
receiving a second device identifier and a second address from a second device;
storing the first device identifier in association with the first address in a database; and
storing the second device identifier in association with the second address in the database,
wherein the first and second addresses each include a different type of address chosen from among the group consisting of: a static Internet Protocol (IP) address, a dynamic IP address, and an auto-configured IP address.
